(19) United States
(12) Patent Application Publication
(10) Pub. No.: US 2017/0365184 A1
(43) Pub. Date: Dec. 21, 2017

(54) System to Re-train One's Reaction to Negative Interference

(71) Applicant: William P. Rogatz, Lansdale, PA (US)

(72) Inventor: William P. Rogatz, Lansdale, PA (US)

(21) Appl. No.: 15/627,209

(22) Filed: Jun. 19, 2017

Related U.S. Application Data
(60) Provisional application No. 62/352,338, filed on Jun. 20, 2016.

(51) Int. Cl. G09B 19/00; G09B 5/02

(52) U.S. Cl. CPC G09B 19/00; G09B 5/02

(57) ABSTRACT

Recognizing that an event or situation has occurred or is about to occur by detecting physical and/or mental changes, such as becoming tense and changes to thoughts, behavior, language, or pace of the body/mind. Delaying any immediate reactions that are considered in response to the event. Reciting the emotions that the event is causing and the triggers for those emotions. Reciting and processing a few replacement thoughts related to the event, emotions, and/or triggers. Visualizing a successful outcome or serene place. Taking physical actions (e.g., deep and slow breaths). The replacement thoughts help control emotions and return an individual to their desired state (e.g., where they perform optimally). The individual should then refocus on what they were doing before the event occurred and handle it without the impact the emotions caused. Adjustments should be made to process the handling of the individual's emotions as required.

### BACKGROUND

Different events occur, or different situations are experienced, every day that impact individuals. The impact may be on, for example, how the individual feels or how the individual acts. The events may happen regularly, such as a driver cutting you off, running late for an event, or getting in an argument with a significant other. Other events may be sudden and surprising, such as news of an employment cutback or a car breakdown. The situations may include, for example, performing in front of others (e.g., giving a presentation at work) or performing in a pressuring situation (e.g., the game on the line).

These events are often stressful and may result in a variety of emotions. The events and emotions caused thereby may cause an individual not to perform at their peak or to act out. While the emotions often subside over time, the reduction in performance or the actions that were taken may have caused issues.

In most situations, the stressful situation is imminent or ongoing, like when the time for the presentation draws nearer or the towing truck is taking its time coming to the rescue. At these times, people often experience prolonged physiological reactions that may last for a long time and have lingering negative effects. The most common approach to dealing with these stressful situations and resultant reactions is to allow for their dissipation over time.

What is needed is a method for recognizing stress-inducing situations as they occur, understanding their triggered physiological and emotional responses, and implementing a series of thoughts and actions to overcome the negative effects of the stress directly in the moment and in any arena.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates an example method for determining an individual's mental and physical attributes associated with the individual performing at their best, according to one embodiment;

FIG. 2 illustrates an example method for determining changes in an individual's mental and physical attributes caused by external factors, according to one embodiment;

FIG. 3 illustrates an example method for determining the impact on performance of an event taking an individual out of their desired state, according to one embodiment;

FIG. 4 illustrates an example method for determining how to return an individual to their desired state after occurrence of an event, according to one embodiment; and

FIG. 5 illustrates an example method for identifying the occurrence of an event and controlling an individual's emotions in response to the event, according to one embodiment.

### DETAILED DESCRIPTION

The current invention is a method for having an individual determine attributes about themselves that are associated with them performing their best (creating their box). The individual then recognizes when something has taken them out of their box, where their performance may not be optimum or where they may act in a way that they would not normally. The individual then determines the emotions associated with these changes and what triggered these emotions. They may then take steps to get themselves back into their box, so that they are at their best.

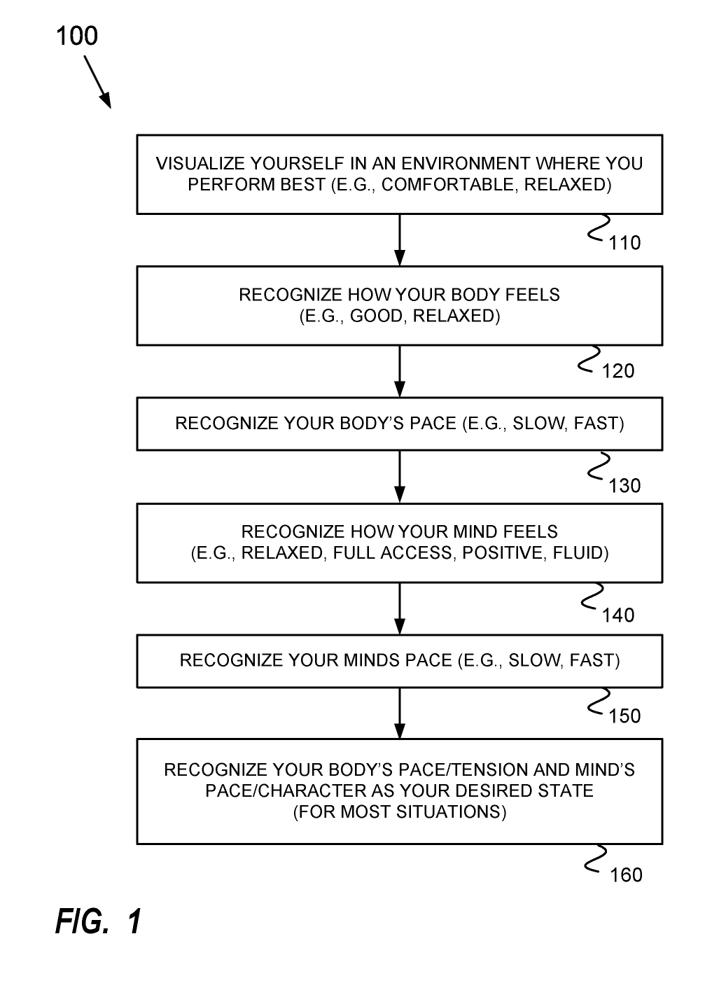

FIG. 1 illustrates an example method 100 for determining an individual's mental and physical attributes associated with the individual performing at their best. Initially, an individual should visualize themselves in an environment where they believe they perform the best 110. This may be a comfortable and relaxing place, such as, for example, sitting on the beach, looking up at the stars, floating down the river, listening to music, or riding a motorcycle on a beautiful day. Once the individual has engrossed themselves in this environment, they should take an inventory of how their body feels 120. For example questions the individual can ask themselves, “Does my body feel relaxed or stressed (most likely relaxed)? Does my body generally feel good? What is my temperature, perspiration level, hydration level, heart rate and pulse?” The individual need not actually measure these values, but rather have a general idea about these items. The individual should recognize the pace of their body in this situation 130. For example, is the pace of their body slow or fast (most likely slow)?

In addition, the individual should take an inventory of how their mind feels 140. For example, is their mind relaxed or stressed (most likely relaxed)? Do they have full access to all of their thoughts? Are their thoughts positive, negative, or neutral (most likely positive)? Does their mind transition from thought to thought smoothly? The individual should recognize the pace of their mind in this situation 150. How fast does their mind shift between thoughts? Is the pace of their mind slow or fast (most likely slow)?

Now that the individual is in this environment and has taken an inventory of their body and mind, the individual should recognize this as their desired state 160. That is, an individual's desired state includes that individual's body having the recognized pace and physical attributes (e.g., tension level) and that individual's mind having the recognized pace and mental attributes (e.g., characteristics of thoughts).

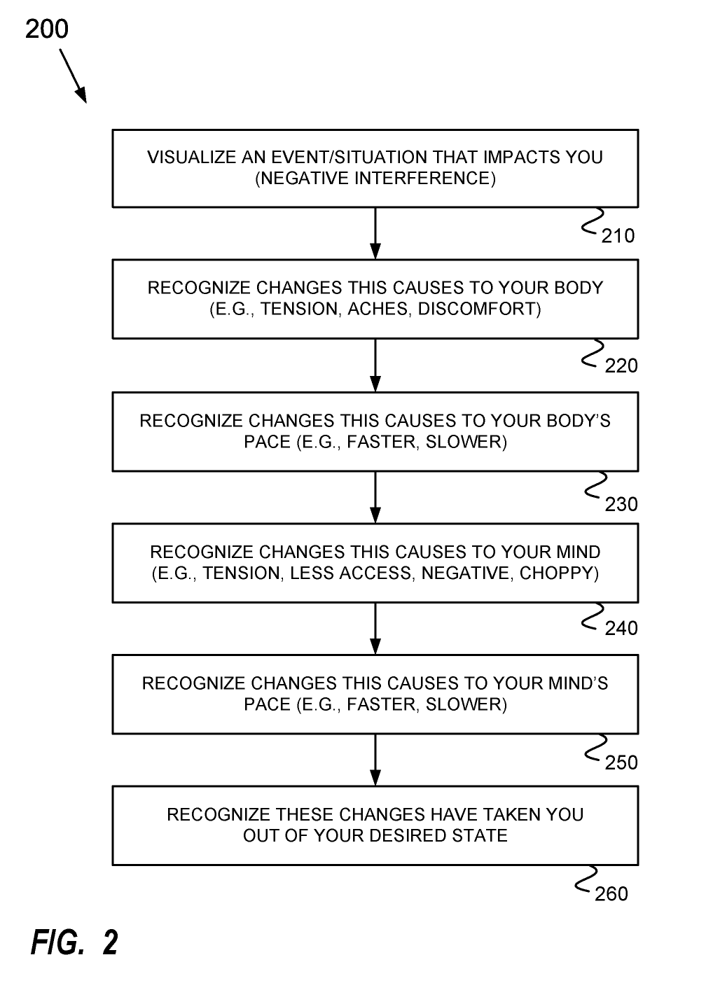

FIG. 2 illustrates an example method 200 for determining changes in an individual's mental and physical attributes caused by external factors. Initially, an individual visualizes an event or situation that causes them stress and impacts them in some way (i.e., negative interference) 210. An event that causes stress normally leads one to respond in some manner. The responses may generally fall into one of three response classes including flight, fight, and freeze. Flight is the desire to retreat or escape from the situation. Fight is the desire to defend oneself or combat the situation. Freeze is a sense of loss with respect to what to do or say.

The event need not be a major event. The event may, for example, be a generic event, an event that impacts a vast majority of people, or an event that is specific to the individual (e.g., work- or school-related). Examples of events or situations may include, for example, merging into traffic, being tailgated, parallel parking on a busy road, undergoing security or police checks, dealing with electronics in disrepair, getting lost, publicly speaking, publicly performing, performing in a pressuring situation (e.g., game on the line, running out of time on a test), lacking knowledge, running late, confronting others, making a mistake, disagreeing with another's point of view, and receiving bad news.

After the event is visualized, changes that this event caused to the body should be recognized 220. The changes to the body may include, for example, tension in various parts of the body, dry mouth, perspiration, lumps in the throat, increased swallowing, butterflies in the stomach, clenching or tightening of the jaw muscles, cold sensations in extremities, tremors, shivers, and jitters. Changes in the body's pace should also be recognized 230. Did the heart rate and pulse change? These values need not actually be measured. Rather a general idea about how these values have changed should be determined. Did the pace of the body increase or decrease (most likely increase)?

Changes that this event may have caused to the mind should also be recognized 240. The changes to the mind may include, for example, involuntary changes in behavior, activity, speech (e.g., rate, tone, volume, and language), unconscious actions or movements, inability to access or retain thoughts, temporary memory loss, distraction, loss of focus, and an interruption in the stream of thought. Changes to the pace of the mind should also be recognized 250. The changes may include, for example, an increase in the rate and/or pace of thought processes and the thoughts becoming more superficial, fractured, or segmented.

After recognizing the changes that have occurred to the body, the body's pace, the mind, and the mind's pace, it should be recognized that the event has taken the individual out of their desired state 260.

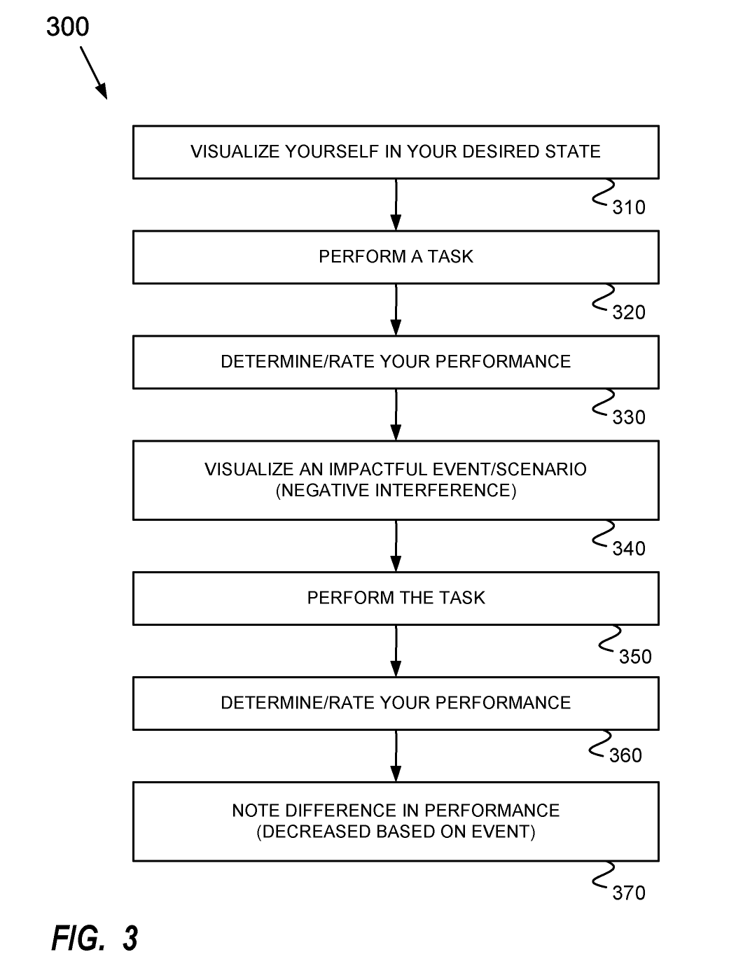

FIG. 3 illustrates an example method 300 for determining the impact on performance of an event taking an individual out of their desired state. Initially, the individual visualizes themselves in their desired state 310 (e.g., the state determined in FIG. 1). The individual performs a task while they are in the desired state 320. The task may be simple or complex. The task may be physical or mental. The task may be, for example, hitting a baseball, giving a presentation, or taking a test. After the task is performed, the performance on the task is rated 330, for example, how often the individual hit the ball, how the presentation went, or how the individual did on the test.

The individual visualizes an event/scenario that causes some kind of impact (causes negative interference) 340. The event may be the event that was visualized above in FIG. 2. After the interference is visualized, the same task is performed 350. A determination is then made regarding the performance on the task (e.g., the task is rated) 360. A comparison is then made between the task being performed in the desired state versus the task being performed with the negative interference 370. The difference in the performance is then noted. The performance typically goes down based on the negative event as the release of adrenaline causes the changes to the body and/or the mind that takes the individual out of their desired state.

FIGS. 1-3 illustrate how negative interferences, such as stress, impact an individual's performance on a task. Now that the impact of different events/situations has been defined on an individual's mental/physical being and the impact this causes has been defined, a method is required that limits the impact of the event, e.g., enables an individual to manage the stress caused by the event, and helps return the individual to their desired place, the method being defined herein.

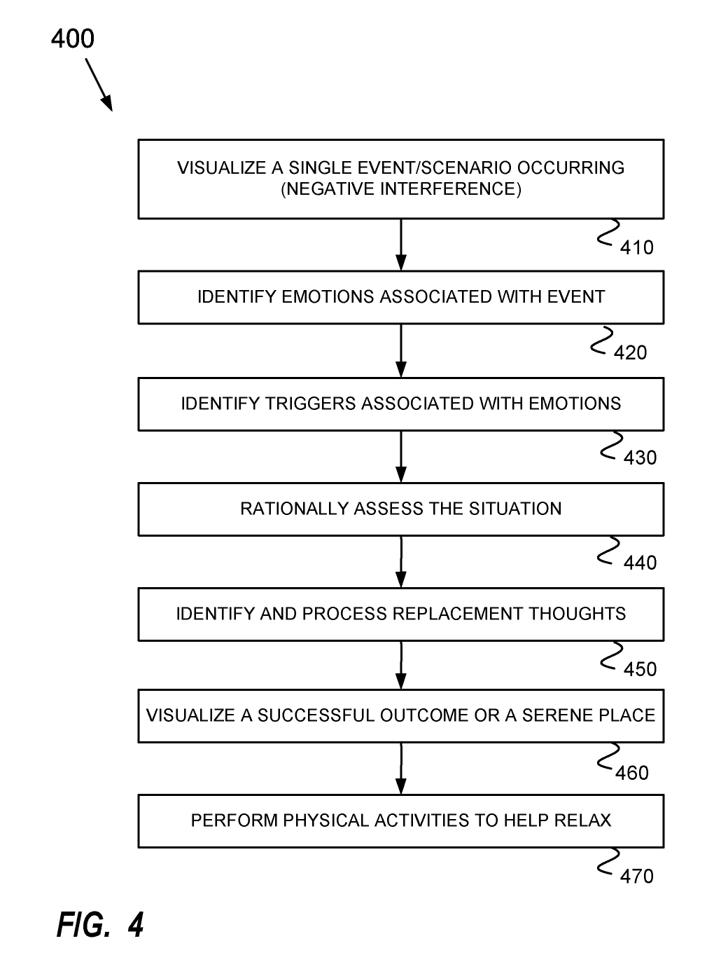

FIG. 4 illustrates an example method 400 for determining how to return an individual to their desired state after occurrence of an event. Initially an individual selects an event and visualizes the event occurring 410. As discussed above, the event may include any number of events that cause a negative interference to an individual. The emotions associated with this event are identified 420. The emotions may include, for example, anger, frustration, fear, and anxiety. The fear and/or anxiety may be, for example, of or related to failure, having done something wrong, embarrassment, a possible conflict, a possible pressuring situation, and uncertainty. The event may cause a single emotion, a succession of emotions, or several emotions simultaneously.

After the emotions have been identified, triggers for the emotions are identified 430. The trigger(s) are the reason(s) and/or circumstance(s) that the particular emotion(s) are experienced. There may only be one trigger, a succession of triggers, or multiple triggers occurring simultaneously to generate any one emotion. Triggers may arise out of the individual's personality traits, pet peeves, genetics, upbringing, habits, views, opinions, and insecurities, but may also arise out of other circumstances. The triggers are not judged or evaluated as to propriety or sufficiency, but merely recognized as relating to generation of a specific emotion in a stress-inducing situation. The triggers may be, for example, fear of what others think, perfectionism, someone not playing by the rules, someone interfering with your goals, need to control everything, desire for success, and uncertainty.

Before an action is contemplated and/or taken regarding the event, a rational assessment of the situation needs to be made 440. The assessment may include, for example, questioning how silly it is to get upset, questioning the amount of energy that will be drained, questioning if an action will make things worse and/or be unpleasant for others, and determining if an action will be productive.

Replacement thoughts are identified and processed that may help diffuse the situation 450. The replacement thoughts serve to mitigate, and may eventually eliminate, the physiological and/or psychological reactions to the stress-inducing event(s). The replacement thoughts may be a single thought or a succession of thoughts. The replacement thoughts may be generic premises or may be tailored to the specific person and/or specific event. The replacement thoughts may be the same in every stress-inducing event and for every emotion, or may vary among events and emotions. The replacement thoughts may be questions, statements, or commands. The replacement thoughts may conceptualize acceptance of the event, reaction, emotion, and/or trigger. The replacement thoughts may address possible consequences of the event, reaction, emotion, and/or trigger, or lack thereof. The replacement thoughts may provide self-motivation, encouragement, or support.

The replacement thoughts may be, for example, “Slow it down,” “Relax,” “One thing at a time,” “What is the worst thing that can happen?” “This can wait,” “How stupid is that,” “Can I control it?” “I can do this,” “I didn't do anything wrong,” “I'm worrying before I have to,” “I am safe,” “I cannot control what others think,” “I have nothing to lose,” “This is where I want to be,” “This is what I want to be doing,” and “I am having fun.”

In addition to rationally assessing the situation and processing replacement thoughts, visualization may be utilized to distract from the event, reaction, emotion, and/or trigger 460. The visualization may be of success as it relates to overcoming the event, reaction, emotion, and trigger. For example, the visualization may be that the event is occurring and that the individual is successfully navigating through the event. The visualization may encompass a different event or situation (e.g., opposite), and the resulting response thereto. The different event/response may result in emotions that would not take the individual out of their desired state and could return them to their desired state (e.g., peace, tranquility, serenity, or other positive and calming emotions). The visualization may be of something completely separate from the event or anything related thereto. The visualization may be to a place where you can relax and be in control of your emotions and/or reactions thereto (e.g., a serene place). The visualization may be to the environment the individual identified as being where they believe they perform the best (e.g., 110 of FIG. 1).

The visualization may be used to support, enhance, or accompany the replacement thought to diffuse the negative reactions and emotions the individual experiences in response to a stress-inducing event. The visualization may not take place in every instance or in combination with every replacement thought. It may be performed before the replacement thought, after the replacement thought, or concurrently with the replacement thought.

If the event causes tension or other physical reactions, some type of physical action may be required 470. The physical action is to help the body relax, release tension, and/or reduce or eliminate other negative physical reactions to the event. The physical action may involve deep, slow breathing, tightening and loosening of the body muscles, or any other similar physical action. The physical action may be used to support, enhance, or accompany the replacement thought to diffuse the negative physiological response the person experiences in a stress-inducing event. The physical action need not take place in every instance or in combination with every replacement thought. It may be performed before the replacement thought, after the replacement thought, or concurrently with the replacement thought.

The method 400 entailed visualizing an event occurring and identifying the emotions that the event caused and the triggers behind those emotions. The method then worked on getting the emotions in check, so as to not act or respond in a manner that would not be typical of the individual or beneficial. While the actions taken may be specific to an event, it should be noted that individuals tend to act the same when the same emotions and/or triggers are involved. As such, the method should be transferable between arenas. That is, if an individual can learn to recognize and control their reactions in one arena (e.g., anger they feel during daily commute), they should be able to transfer that to other arenas (e.g., anger they feel when an umpire makes a bad call).

The method 400 can be practiced for events that cause a plurality of different emotions, so that an individual's reactions to the various emotions can be practiced. The more an individual practices, the more likely they will be able to successfully implement the method in a real situation. Additionally, the more they practice, the more likely they are to identify the fact that a situation has occurred or is likely to occur.

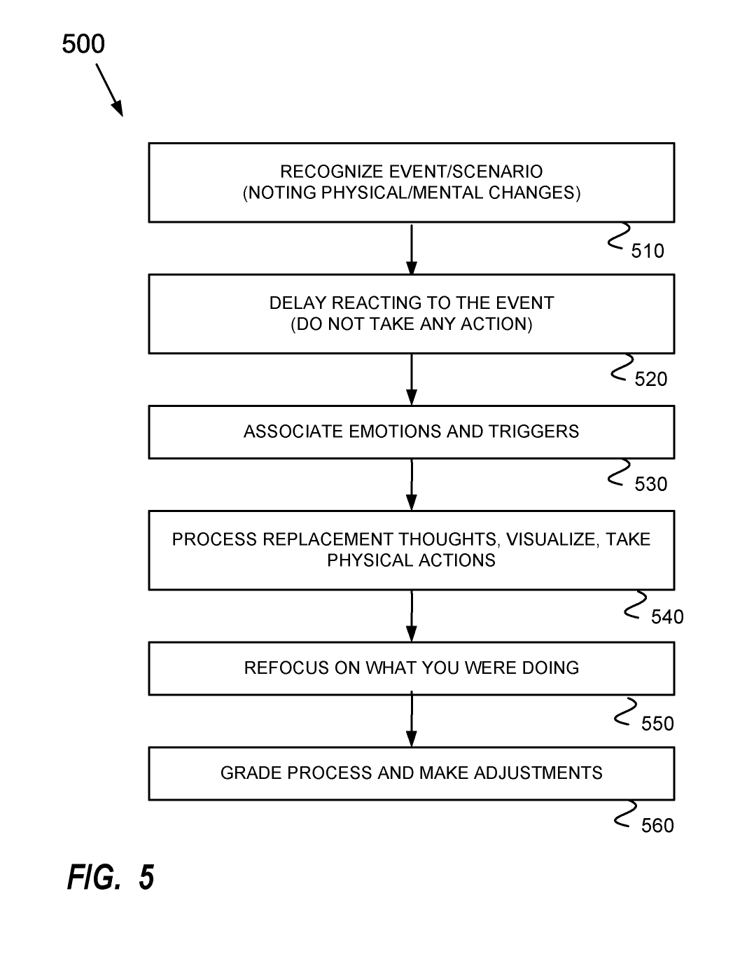

FIG. 5 illustrates an example method 500 for identifying the occurrence of an event and controlling an individual's emotions in response to the event. Initially, an individual recognizes that an event or situation has occurred or is about to occur 510. The individual may recognize this by detecting physical and/or mental changes (e.g., those discussed with respect to FIG. 2). For example, the individual may become tense, notice changes to their thoughts, behavior or language, or notice changes in the pace of their body and/or mind. After the individual makes the determination that the event is occurring or is about to occur, they want to delay any immediate reactions that they are considering taking in response thereto 520. This delay will allow the individual to process the situation prior to acting.

The individual should recite the emotions that the event is causing and the triggers for those emotions 530. Once they identify the emotions and triggers, they should recite and process a few replacement thoughts related to the event, emotions, and/or triggers 540. In addition to the replacement thoughts, they may also visualize (e.g., successful outcome, serene place) and/or take physical actions (e.g., take deep and slow breaths). The replacement thoughts should help the individual control their emotions and return them to their desired state, so that they can function in an optimal manner.

After the individual has taken steps to control their emotions, they should refocus on what they were doing (the task at hand) when they recognized that the event had occurred 550. After the individual finishes with the task at hand, they should grade the process by which they attempted to control their emotions 560. A determination should be made regarding whether adjustments need to be made and if so, the adjustments should be made.

It should be noted that the more the method is practiced, the quicker the method may be performed and become more effective over time at diffusing negative reactions and emotions. Repetition of the method also enables recognition of crossover patterns of reactions, emotions, triggers, and replacement thoughts to events across arenas, facilitating standardization of the method in application. Repeated practice of the method also enables consistency of use, as well as the making of any adjustments, adaptations, or corrections in execution of the method to increase or maintain its effectiveness. After extended practice, the individual may be able to diffuse reactions almost immediately, or prevent them almost entirely. The person may also develop the ability to address or to newly address multiple events, reactions, emotions, and triggers concurrently.

The steps of the method may each be performed once, or multiple times, in any given event, action, activity, situation, or occurrence. Over time, the method may be altered or adapted, or alternatively standardized, depending on its practitioner, event, reaction, emotion, or trigger. The method may not necessarily replace the reactions and emotions experienced in an event, but instead provide a system for active focus and control over those reactions and emotions in oneself.

Over time it may be possible that the individual does not need to associate emotions and/or triggers to the event in order to process replacement thoughts, but instead can process the replacement thoughts after determination of the event. Furthermore, the individual may eventually be able to determine the physiological and psychological states of others and take that into account.

The methods may be affected or modified based on, for example, fatigue, poor nutrition, caffeine, alcohol, drugs, or distractions to the person's attention (e.g., electronic devices).

Various items may be utilized to assist with the methods described above. For example, cards may be utilized that identify possible replacement thoughts for different emotions. A software app may be utilized for tracking physical and mental changes, emotions, triggers, and replacement thoughts for various events. The software app may be utilized to track how well an individual was able to control their emotions for different events (e.g., how well they performed on a task after an event occurred). An activity monitor may be utilized to track various physical attributes related to an individual. The physical attributes may be utilized to detect when changes are occurring that may be associated with an event happening (e.g., heart rate increasing) or with the replacement thoughts working with regard to controlling the emotions (e.g., heart rate decreasing).

Although the disclosure has been illustrated by reference to specific embodiments, it will be apparent that the disclosure is not limited thereto, as various changes and modifications may be made thereto without departing from the scope. Reference to “one embodiment” or “an embodiment” means that a particular feature, structure, or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A method to handle negative interference, the method comprising:
determining physical and mental attributes associated with an individual being in an environment in which they can function best;
detecting changes to the physical and mental attributes occurring, wherein the changes are indicative of an occurrence of a negative interference;
associating emotions with the negative interference;
associating triggers with the emotions; and
processing one or more replacement thoughts to mitigate negative thoughts or negative actions that could occur as a result of the emotions.

2. The method of claim 1, further comprising visualizing performing a task at hand successfully even with the negative interference.

3. The method of claim 1, further comprising visualizing a serene environment.

4. The method of claim 1, further comprising performing a physical action to assist with a change in a physical attribute that was detected.

5. The method of claim 1, wherein the physical attributes include tension level and pace.

6. The method of claim 1, wherein the mental attributes include thought characteristics and pace.

7. The method of claim 1, wherein the changes to the physical attributes detected include at least one of an increase in tension and an increase in pace.

8. The method of claim 1, wherein the changes to the mental attributes detected include at least one of an increase in negativity of thoughts, a decrease in access to thoughts, and an increase in pace.

9. The method of claim 1, wherein the negative interference is an event.

10. The method of claim 1, wherein the negative interference is a situation.

11. The method of claim 1, wherein the determining physical and mental attributes associated with the individual being in the environment in which they can function best includes visualizing themselves being in the environment, recognizing how their body feels, recognizing their body's pace, recognizing how their mind feels, and recognizing their mind's pace.

12. The method of claim 1, wherein the emotions include at least some subset of anger, frustration, fear, and anxiety.

13. The method of claim 1, further comprising refocusing on tasking that was being performed prior to detecting the changes to the physical and mental attributes indicative of the occurrence of the negative interference.

14. The method of claim 1, further comprising delaying any action for a period of time subsequent to detecting the changes to the physical and mental attributes indicative of the occurrence of the negative interference.

15. A method to handle negative interference, the method comprising:
performing a task;
detecting changes to physical and mental attributes associated with an individual during the performance of the task, wherein the changes are indicative of an occurrence of a negative interference;
delaying performance of the task or taking any action on the negative interference for a period of time;
processing one or more replacement thoughts to mitigate negative thoughts or negative actions related to the negative interference; and
refocusing on the task.

16. The method of claim 15, further comprising
associating emotions with the negative interference; and
associating triggers with the emotions.

17. The method of claim 15, further comprising visualizing performing the task successfully even with the negative interference.

18. A method to retrain an individual's reactions to emotions experienced during negative interference, the method comprising:
determining physical and mental attributes associated with an individual being in an environment in which they can function best;
visualizing a negative interference;
identifying emotions associated with the negative interference;
identifying triggers associated with the emotions;
rationally accessing the negative interference; and
identifying one or more replacement thoughts related to the negative interference, wherein the replacement thoughts are to mitigate negative thoughts or negative actions.

19. The method of claim 18, further comprising determining changes to physical and mental attributes associated with the individual during the negative interference.

20. The method of claim 15, further comprising visualizing responding successfully to the negative interference.
